(19) United States
(12) Patent Application Publication
(10) Pub. No.: US 2026/0147665 A1
(43) Pub. Date: May 28, 2026

(54) SELF-HEALING AGENT FOR SELF-CHECKOUT

(71) Applicant: NCR Voyix Corporation, Atlanta, GA (US)

(72) Inventors: Michael Jiang Tang, Alpharetta, GA (US); Kun Zhu, Smyrna, GA (US); Jacob Regis Cronauer, Marietta, GA (US)

(21) Appl. No.: 18/963,133

(22) Filed: Nov. 27, 2024

(51) Int. Cl. G06F 11/07; G06F 8/65; G06F 11/14

(52) U.S. Cl. CPC G06F 11/0793; G06F 8/65; G06F 11/0751; G06F 11/1441

(57) ABSTRACT

System and techniques may be used for addressing errors at a point of purchase device. An example technique may include detecting, at a point of purchase device, an error code of the point of purchase device, determining, using a small language model, a response corresponding to the error code, the response including at least one action to remedy the error code, and generating, using the small language model, a command line prompt based on the response. The example technique may include executing the command line prompt at the point of purchase device.

### BACKGROUND

Point of purchase devices are commonly found in retail environments and enable customers to complete transactions using various payment methods, such as credit cards, debit cards, or mobile payments. Point of purchase devices typically connect to payment processors through secure networks to validate and process transactions in real-time. When a point of purchase device malfunctions or experiences technical issues, typically a qualified technician is required to diagnose and repair the device.

### SUMMARY

In various embodiments, methods and systems are disclosed for addressing errors at a point of purchase device.

According to an embodiment, a technique may include detecting, at a point of purchase device, an error code of the point of purchase device, determining, using a small language model, a response corresponding to the error code, the response including at least one action to remedy the error code, and generating, using the small language model, a command line prompt based on the response, and executing the command line prompt at the point of purchase device.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 illustrates a system for addressing errors at a point of purchase device in accordance with some examples.

FIG. 2 illustrates a schematic diagram for identifying and correcting errors in a point of purchase device in accordance with some examples.

FIG. 3 illustrates a machine learning engine for training and execution related to address errors at a point of purchase device in accordance with some examples.

FIG. 4 illustrates generally a flowchart showing a technique for addressing errors at a point of purchase device in accordance with some examples.

FIG. 5 illustrates generally an example of a block diagram of a machine upon which any one or more of the techniques discussed herein may perform in accordance with some embodiments.

### DETAILED DESCRIPTION

Systems, methods, techniques, and methodologies described herein may use a small language model on a point of purchase device (e.g., a self-checkout terminal, a cash-handling device, etc.) to remedy an error on the point of purchase device, for example without any human involvement. The error may be automatically identified by the small language model, which may query a knowledge base to determine an appropriate step to fix the error. The small language model may output in instruction (e.g., a command line instruction) to a command line of the point of purchase device to implement the fix to the error. The small language model may generate the instruction based on the appropriate step from the knowledge base, which may include a generic command line instruction, for example.

Current manual troubleshooting processes are labor-intensive and time-consuming, leading to increased downtime, higher operational costs, and reduced customer satisfaction. By automating diagnostics or error-resolution at a point of purchase device, the small language model may be used to minimize the manual process inefficiencies and improve overall system performance.

The small language model may be used to interpret an error code, such as from real-time telemetry data. The error code may be cross-referenced with a knowledge base of machine learning-derived solutions. The small language model may autonomously execute a corrective action, such as resetting a component, recalibrating a sensor, or the like. When an error is not resolvable automatically, the small language model may generate or output a detailed diagnostic indication, for example including a recommendation for remedying the error.

Automating the troubleshooting process with the small language model offers several benefits, such as reduced system downtime, decreased need for manual intervention (saving time), and improved customer satisfaction due to the quick resolution of issues. The small language model can be rapidly deployed at a retail environment, for example without needing a hardware upgrade, because the small language model is efficient.

In an example, the systems and techniques described herein provide a technical solution to the technical problem of errors occurring at a point of purchase device. This example technical solution overcomes the limited memory, processing power, or other physical or computing resources of a point of purchase device by implementing a small language model to address the errors. The small language model may accurately address errors at the point of purchase device while operating with the limited resources. The small language model may output a command to a command line prompt for execution, for example in a specified code or format corresponding to operation of the point of purchase device when executed at the command line prompt.

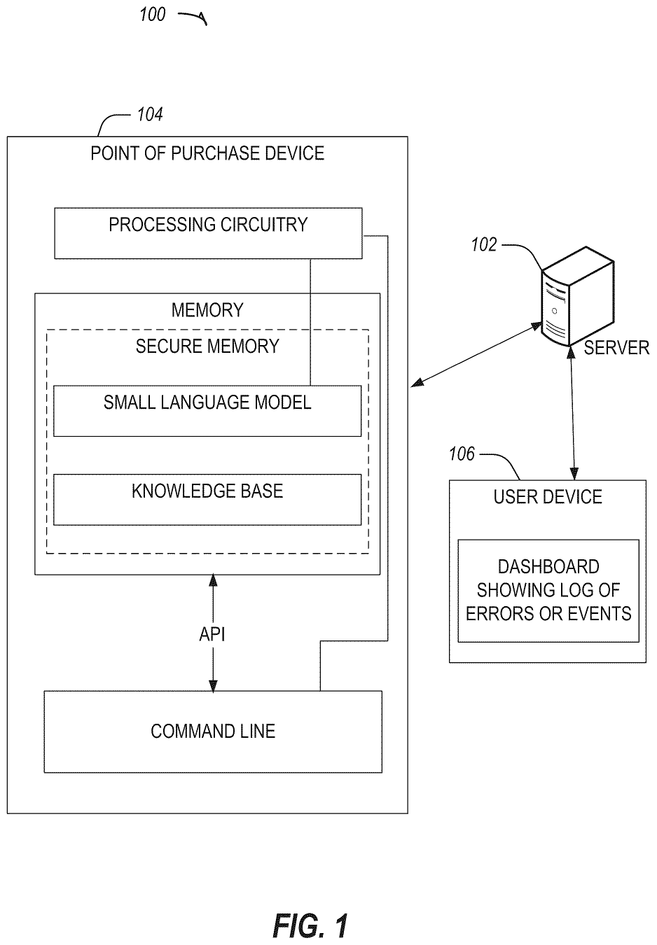

FIG. 1 illustrates a system 100 for addressing errors at a point of purchase device in accordance with some examples. The system 100 includes appoint of purchase device 104, a server 102, and optionally a user device 106 to display a dashboard showing a log of errors or events. The server 102 may communicate with the point of purchase device 104, for example to receive information corresponding to an error or event (e.g., a response to an error).

The point of purchase device 104 includes processing circuitry to execute a small language model, which is stored in memory of the point of purchase device 104 (and optionally in secure memory of the point of purchase device 104). The processing circuitry may execute a command via a command line, which may communicate with he small language model via an application programming interface (API). In some examples, the processing circuitry includes separate processing circuitry for the small language model and the command line.

The small learning model may be used to autonomously diagnose or resolve issues based on an error code detected from telemetry data of the point of purchase device 104. The small language model may be used to determine which troubleshooting or resolution step is next or needed to resolve an issue based on generative and inferencing capabilities. These capabilities are grounded in user written documentation or technical product documentation (e.g., in a knowledge base stored on the point of purchase device 104).

When an issue occurs, the small language model may search the knowledge base to select one or more (e.g., a set, such as 3, 5, 10) most relevant documents. After retrieving the one or more most relevant documents, the small language model may re-order the documents based on a specific error message detected. The small language model may generate a resolution step based on the error message and the one or more most relevant documents. The resolution step may be implemented by the small language model by outputting a command to the command line via an API. In some examples, a set of steps may be taken (e.g., a second step after the first resolution step). The set of steps may be stored in a the knowledge base, otherwise in the memory of the point of purchase device 104, remotely at the server 102, or the like. In some examples, the server 102 may periodically, on demand, or otherwise update the knowledge base on the point of purchase device 104.

The small language model may be trained using domain specific language or information, such as based on point of purchase device troubleshooting processes, device-specific information, known error codes, responses to error codes, or the like. The small language model does not need as much data to be trained when compared to a large language model. The small language model may be stored efficiently in the memory of the point of purchase device 104 (e.g., taking up a small amount of memory), and may be trained quickly to be tailored to the specific application of the resolving errors at the point of purchase device 104. The small language models may allow confidential data to be stored on the point of purchase device 104 and optionally not removed from the point of purchase device 104. The small language model may operate without communicating with the server 102, in some examples. An example confidential data includes how to open a cash box and replenish cash. To fix an error related to this confidential information, the small language model may be trained using a confidential technique. Since the small language model is stored on and operations at the point of purchase device 104, the confidential data and confidential resolution technique may be kept confidential.

The small language model may be trained using training data such as register documentation, previous incidents, user manuals, or an active register health. The term small language model may refer to the use of these data sets, with a finite purpose around diagnosing issues related to these data sets.

The small language model may operate as an agent embedded in the point of purchase device 104. A language model agent is a type of artificial intelligence that may understand and generate human language, enabling it to perform tasks such as answering questions, providing recommendations, analyzing text, or executing a command line prompt.

The small language model may be trained on approved code patches, troubleshooting fixes, or other solutions to common issues or errors. Through an API connections to the command line of the point of purchase device 104, the agent has root access to run one or more pre-approved changes to the point of purchase device 104. These pre-approved changes may be outlined in documentation of the knowledge base, and used by the small language model to recognize changes in procedure when new versions are introduced. The small language model may continually provide vetted and up-to-date responses to the agent to resolve an error on the point of purchase device 104. The small language model may compile information on common issues and diagnostic steps, and output a best course of action to the agent, which has the necessary permissions to autonomously fix the issue via a command line prompt.

The agent may connect the small language model to a code notebook with one or more library operators (e.g., in Python) to allow the agent to make a call to the knowledge base, logically link an error to a pre-approved fixe found in the documentation, and output an instruction on the command line.

The small language model may save an error, event, action, or the like in memory of the point of purchase device 104 or send the information to the server 102. The server 102 may generate a dashboard or webpage to track actions or display a log of events, such as on the user device 106. In some examples, the small language model may output information corresponding to reasoning for why an action to remedy an error was selected for the error. This reasoning may be output to the server 102 for display on the user device 106. In an example, frequency of error codes may be saved to the log. For example, when error code “431” occurs more often than other error codes, the cause of the error “431” may be prioritized in software development bug fixes.

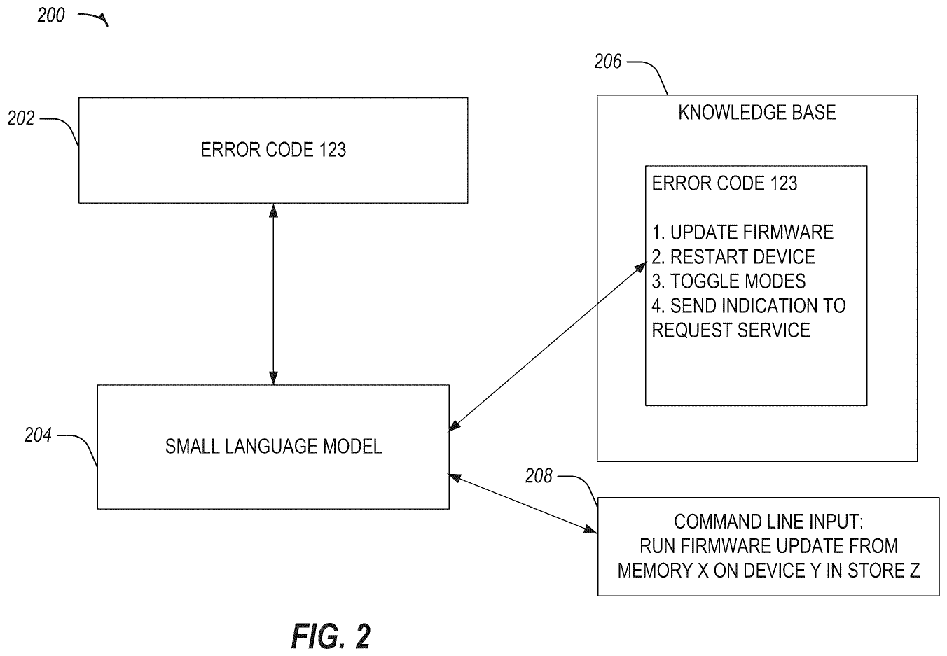

FIG. 2 illustrates a schematic diagram 200 for identifying and correcting errors in a point of purchase device in accordance with some examples. The schematic diagram 200 illustrates a particular error code 202, which is identified by a small language model 204. The small language model 204 may query a knowledge base 206 to determine steps related to the error code 202. The small language model 204 may use the knowledge base 206 information to generate a command line input 208. For example, the knowledge base 206 may indicate that a firmware update for a device may be useful for addressing the error code 202. The small language model 204 may use this information to generate an input for running in a command line to update memory. The information in the knowledge base may be generic or not specific to the device the small language model 204 is operating on, and the small language model 204 may configure the input based on the device. For example, the input in pseudocode may include “run firmware update from memory x on device y in store z.” The memory location, the device, and the store may be learned by the small language model 204 during training. The knowledge base 206 may indicate that this information is used in updating firmware, or the small language model 204 may determine based on the context and language in the knowledge base 206 that this information is to be used.

In an example, the small language model 204 may generate syntax for the error code 202. For example, the error code 202 may occur on machine “DT97” in the store “LMN98,” and the small language model 204 may retrieve information from the knowledge base 206 related to addressing the error code 202. The small language model 204 may insert machine information (e.g., “DT97”) or store information (e.g., “LMN98”) to code corresponding to the retrieved information to allow the code to run in the store and on the machine. The modified code may be sent to the command line input 208 for execution at the machine. The retrieved information may include a generic script or code before modification by the small language model 204.

In some examples, the knowledge base 206 may store a set of suggestions for remedying a particular error, such as the error 202. In the example shown in FIG. 2, there are four different suggestions for addressing the error 202 in the knowledge base 206. The suggestions may be ordered (e.g., the small language model 204 may be programmed to attempt the suggestions in order starting with the first in the list as stored in the knowledge base 206). For the error code 202, the knowledge base 206 includes four suggestions, including updating firmware, restarting the device, toggling modes (e.g., switching to an assist mode from a self-check out mode), and sending an indication to request service (e.g., to a technician dashboard). While listed in order, the small language model 204, in some examples, may determine that attempting the suggestions out of order is appropriate and proceed accordingly (e.g., restart the device first). In other examples, the suggestions may not be ordered and the small language model 204 may determine which suggestion to attempt first (e.g., based on its training). The small language model 204 may send code for execution on the command line input 208 automatically after determining the error 202 and a fix from the knowledge base 206. Other example fixes may include recalibrating a sensor, restarting a component (e.g., a camera or a scanner), recalibrating a component (e.g., a scanner), or downloading software or firmware. In an example, an error may occur, and without any human intervention, the command line input 208 may execute code to fix the error. The small language model 204 may be configured to output an indication for display on the machine having the error 202 (e.g., “please use a different terminal”). In some examples, the small language model 204 may identify an error that is not preventing use of a machine but that may be fixed (e.g., an error that may present an issue in a long term, over a day, a week, a month, etc., but that is not stopping operation). In these examples, the small language model 204 may be configured to fix the error when there is down time for the machine (e.g., at night, after a store is closed, etc.). In some examples, the small language model 204 may perform preventative maintenance, such as when one error code is identified in the knowledge base 206 as likely to lead to a second error code or is related to the second error code. In these examples, the small language model 204 may address the second error code as well. In some examples, the small language model 204 may identify an indicator event that signals that an error will occur in the near future. In these examples, the small language model 204 may perform a preventative action, such as restarting a machine to avoid the error or the event.

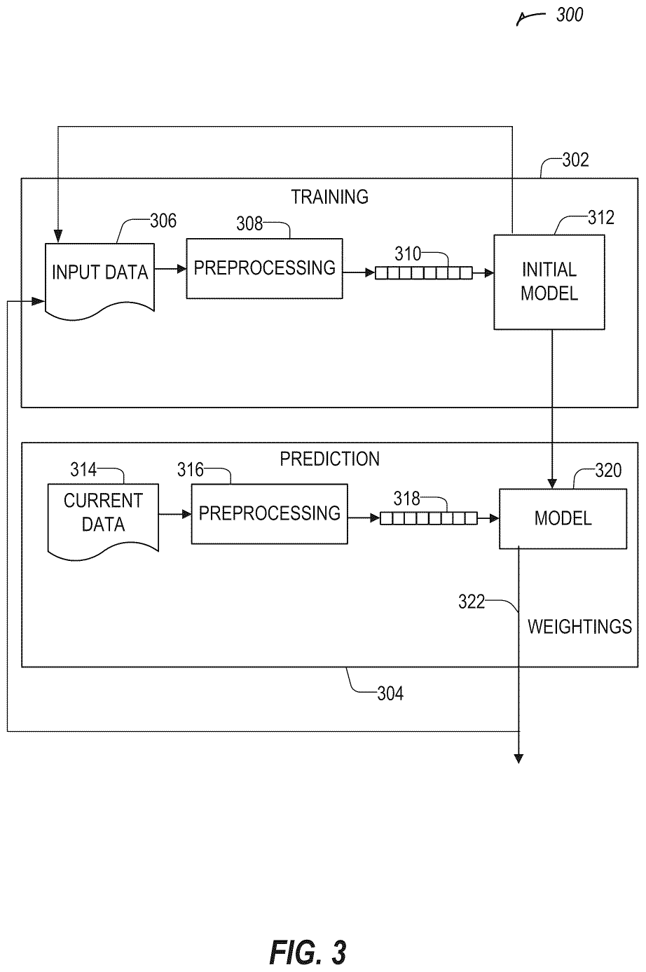

FIG. 3 illustrates a machine learning engine for training and execution related to address errors at a point of purchase device. The machine learning engine may be deployed to execute at a mobile device (e.g., a cell phone, a tablet, etc.) or a computer (e.g., a desktop, a laptop, etc.). FIG. 3 shows an example machine learning engine 300 according to some examples of the present disclosure.

Machine learning engine 300 uses a training engine 302 and a prediction engine 304. Training engine 302 uses input data 306, for example after undergoing preprocessing component 308, to determine one or more features 310. The one or more features 310 may be used to generate an initial model 312, which may be updated iteratively or with future labeled or unlabeled data (e.g., during reinforcement learning), for example to improve the performance of the prediction engine 304 or the initial model 312. An improved model may be redeployed for use.

The input data 306 may include an error code, a set of error codes, a previous fix to an error code, etc.

In the prediction engine 304, current data 314 (e.g., two items in a pair) may be input to preprocessing component 316. In some examples, preprocessing component 316 and preprocessing component 308 are the same. The prediction engine 304 produces feature vector 318 from the preprocessed current data, which is input into the model 320 to generate one or more criteria weightings 322. The criteria weightings 322 may be used to output a prediction, as discussed further below.

The training engine 302 may operate in an offline manner to train the model 320 (e.g., on a server). The prediction engine 304 may be designed to operate in an online manner (e.g., in real-time, at a mobile device, on a wearable device, etc.). In some examples, the model 320 may be periodically updated via additional training (e.g., via updated input data 306 or based on labeled or unlabeled data output in the weightings 322) or based on identified future data, such as by using reinforcement learning to personalize a general model (e.g., the initial model 312) to a particular user.

Labels for the input data 306 may include a fix to an error code, a set of suggested steps, a knowledge base, information corresponding to operation of a machine, manufacturing information for a machine, or the like.

The initial model 312 may be updated using further input data 306 until a satisfactory model 320 is generated. The model 320 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 302 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 302. In an example embodiment, a regression model is used and the model 320 is a vector of coefficients corresponding to a learned importance for each of the features in the vector of features 310, 318. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

A language model may include a large language model (LLM), a natural language processing (NLP) model, or the like. Large Language Models (LLMs) are advanced artificial intelligence systems trained on vast amounts of text data to understand and generate human-like language. These models use deep learning techniques, particularly transformer architectures, to process and produce coherent and contextually relevant text across a wide range of topics and tasks. A NLP model is a model that analyzes and processes text data to translate, perform sentiment analysis, or generate text based on context.

A small language model may be a trained model that only occupies a small amount of memory (e.g., below a threshold). The small language model may use a comparatively lower amount of computational power from a host machine (e.g., relative to a large language model). The small language model may be adaptable to many machines. The small language model may be quickly installed and deployed on various platforms.

Once trained, the model 320 may output a prediction, such as a fix for an error code, such as code for operation in a command prompt, a reason for using a fix (e.g., to save in a log), a restart device command or suggestion, or the like.

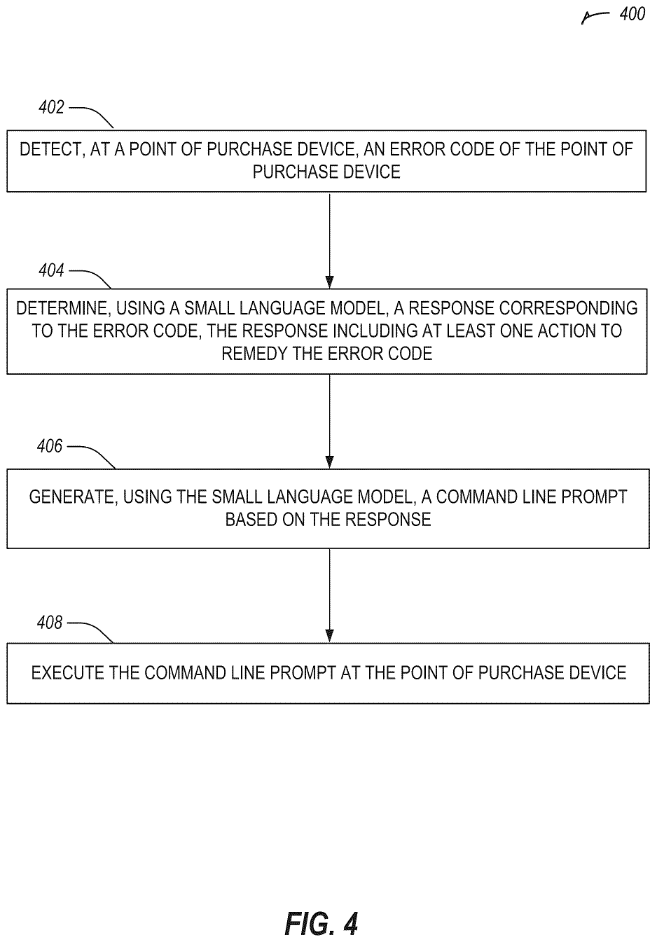

FIG. 4 illustrates generally a flowchart showing a technique 400 for addressing errors at a point of purchase device in accordance with some examples. The point of purchase device may be a self-checkout device.

The technique 400 includes an operation 402 to detect, at a point of purchase device, an error code of the point of purchase device.

The technique 400 includes an operation 404 to determine, using a small language model, a response corresponding to the error code, the response including at least one action to remedy the error code. The small language model may be trained on approved code patches and troubleshooting fixes that solve a set of error codes. The small language model may be configured to use no more than a portion of memory of the point of purchase device below a first threshold or to be limited to operate with no more computational power of the point of purchase device than an amount below a second threshold. The small language model may be stored in protected memory of the point of purchase device.

The technique 400 includes an operation 406 to generate, using the small language model, a command line prompt based on the response. The response may include a generic version of the command line prompt. In an example, generating the command line prompt includes adding syntax corresponding to a store location of the point of purchase device and a model of the point of purchase device to the generic version of the command line prompt. The response may include a set of knowledge articles corresponding to the error code. The response may include a set of ordered command line prompts, including the command line prompt as a first command line prompt in order, and the small language model may be configured to attempt the set of ordered command line prompts in order.

The technique 400 includes an operation 408 to execute the command line prompt at the point of purchase device. Operation 408 may include using an application programming interface (API) connection to a command line of the point of purchase device. The response may include restarting the point of purchase device. In an example, operation 408 causes the point of purchase device to restart. The response may include an upgrade to software of the point of purchase device. In an example, operation 408 causes the point of purchase device to upgrade the software.

The technique 400 may include outputting an indication for display on a display device of the point of purchase device that the point of purchase device is out of order in response to detecting the error code. The technique 400 may include outputting the error code, the response, and an indication of whether the response fixed the error code, for example for storing in a remote log.

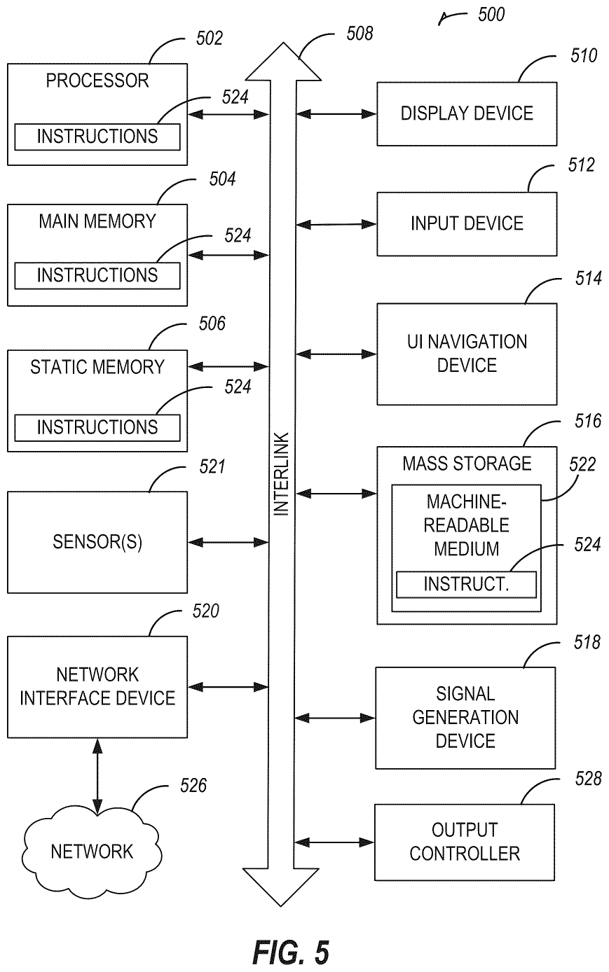

FIG. 5 illustrates generally an example of a block diagram of a machine 500 upon which any one or more of the techniques discussed herein may perform in accordance with some examples. In alternative examples, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, alphanumeric input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 that is non-transitory on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

Each of these non-limiting examples may stand on its own, or may be combined in various permutations or combinations with one or more of the other examples.

Example 1 is a method comprising: detecting, at a point of purchase device, an error code of the point of purchase device; determining, using a small language model, a response corresponding to the error code, the response including at least one action to remedy the error code; generating, using the small language model, a command line prompt based on the response; and executing the command line prompt at the point of purchase device.

In Example 2, the subject matter of Example 1 includes, wherein the response includes a generic version of the command line prompt and wherein generating the command line prompt includes adding syntax corresponding to a store location of the point of purchase device and a model of the point of purchase device to the generic version of the command line prompt.

In Example 3, the subject matter of Examples 1-2 includes, wherein the small language model is trained on approved code patches and troubleshooting fixes that solve a set of error codes.

In Example 4, the subject matter of Examples 1-3 includes, wherein executing the command line prompt includes using an application programming interface (API) connection to a command line of the point of purchase device.

In Example 5, the subject matter of Examples 1-4 includes, wherein the response includes restarting the point of purchase device, and wherein the command line prompt, when executed, causes the point of purchase device to restart.

In Example 6, the subject matter of Examples 1-5 includes, wherein the response includes an upgrade to software of the point of purchase device, and wherein the command line prompt, when executed, causes the point of purchase device to upgrade the software.

In Example 7, the subject matter of Examples 1-6 includes, wherein the small language model is configured to use no more than a portion of memory of the point of purchase device below a first threshold and to be limited to operate with no more computational power of the point of purchase device than an amount below a second threshold.

In Example 8, the subject matter of Examples 1-7 includes, wherein the point of purchase device is a self-checkout device.

In Example 9, the subject matter of Examples 1-8 includes, wherein the response includes a set of knowledge articles corresponding to the error code.

In Example 10, the subject matter of Examples 1-9 includes, wherein the response includes a set of ordered command line prompts, including the command line prompt as a first command line prompt in order, the small language model configured to attempt the set of ordered command line prompts in order.

In Example 11, the subject matter of Examples 1-10 includes, wherein the small language model is stored in protected memory of the point of purchase device.

In Example 12, the subject matter of Examples 1 -11 includes, outputting an indication for display on a display device of the point of purchase device that the point of purchase device is out of order in response to detecting the error code.

In Example 13, the subject matter of Examples 1-12 includes, outputting the error code, the response, and an indication of whether the response fixed the error code for storing in a remote log.

Example 14 is a point of purchase device comprising: processing circuitry; and memory, including instructions, which when executed by the processing circuitry, cause the processing circuitry to perform operations comprising: detecting an error code of the point of purchase device; determining, using a small language model, a response corresponding to the error code, the response including at least one action to remedy the error code; generating, using the small language model, a command line prompt based on the response; and executing the command line prompt at the point of purchase device.

In Example 15, the subject matter of Example 14 includes, wherein the response includes a generic version of the command line prompt and wherein generating the command line prompt includes adding syntax corresponding to a store location of the point of purchase device and a model of the point of purchase device to the generic version of the command line prompt.

In Example 16, the subject matter of Examples 14-15 includes, wherein the small language model is trained on approved code patches and troubleshooting fixes that solve a set of error codes.

In Example 17, the subject matter of Examples 14-16 includes, wherein executing the command line prompt includes using an application programming interface (API) connection to a command line of the point of purchase device.

Example 18 is at least one machine-readable medium, including instructions, which when executed by processing circuitry, cause the processing circuitry to perform operations comprising: detecting an error code of a point of purchase device; determining, using a small language model, a response corresponding to the error code, the response including at least one action to remedy the error code; generating, using the small language model, a command line prompt based on the response; and executing the command line prompt at the point of purchase device.

In Example 19, the subject matter of Example 18 includes, wherein the response includes a generic version of the command line prompt and wherein generating the command line prompt includes adding syntax corresponding to a store location of the point of purchase device and a model of the point of purchase device to the generic version of the command line prompt.

In Example 20, the subject matter of Examples 18-19 includes, wherein the small language model is trained on approved code patches and troubleshooting fixes that solve a set of error codes.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
detecting, at a point of purchase device, an error code of the point of purchase device;
determining, using a small language model, a response corresponding to the error code, the response including at least one action to remedy the error code;
generating, using the small language model, a command line prompt based on the response; and
executing the command line prompt at the point of purchase device.

2. The method of claim 1, wherein the response includes a generic version of the command line prompt and wherein generating the command line prompt includes adding syntax corresponding to a store location of the point of purchase device and a model of the point of purchase device to the generic version of the command line prompt.

3. The method of claim 1, wherein the small language model is trained on approved code patches and troubleshooting fixes that solve a set of error codes.

4. The method of claim 1, wherein executing the command line prompt includes using an application programming interface (API) connection to a command line of the point of purchase device.

5. The method of claim 1, wherein the response includes restarting the point of purchase device, and wherein the command line prompt, when executed, causes the point of purchase device to restart.

6. The method of claim 1, wherein the response includes an upgrade to software of the point of purchase device, and wherein the command line prompt, when executed, causes the point of purchase device to upgrade the software.

7. The method of claim 1, wherein the small language model is configured to use no more than a portion of memory of the point of purchase device below a first threshold and to be limited to operate with no more computational power of the point of purchase device than an amount below a second threshold.

8. The method of claim 1, wherein the point of purchase device is a self-checkout device.

9. The method of claim 1, wherein the response includes a set of knowledge articles corresponding to the error code.

10. The method of claim 1, wherein the response includes a set of ordered command line prompts, including the command line prompt as a first command line prompt in order, the small language model configured to attempt the set of ordered command line prompts in order.

11. The method of claim 1, wherein the small language model is stored in protected memory of the point of purchase device.

12. The method of claim 1, further comprising outputting an indication for display on a display device of the point of purchase device that the point of purchase device is out of order in response to detecting the error code.

13. The method of claim 1, further comprising outputting the error code, the response, and an indication of whether the response fixed the error code for storing in a remote log.

14. A point of purchase device comprising:
processing circuitry; and
memory, including instructions, which when executed by the processing circuitry, cause the processing circuitry to perform operations comprising:
detecting an error code of the point of purchase device;
determining, using a small language model, a response corresponding to the error code, the response including at least one action to remedy the error code;
generating, using the small language model, a command line prompt based on the response; and
executing the command line prompt at the point of purchase device.

15. The point of purchase device of claim 14, wherein the response includes a generic version of the command line prompt and wherein generating the command line prompt includes adding syntax corresponding to a store location of the point of purchase device and a model of the point of purchase device to the generic version of the command line prompt.

16. The point of purchase device of claim 14, wherein the small language model is trained on approved code patches and troubleshooting fixes that solve a set of error codes.

17. The point of purchase device of claim 14, wherein executing the command line prompt includes using an application programming interface (API) connection to a command line of the point of purchase device.

18. At least one machine-readable medium, including instructions, which when executed by processing circuitry, cause the processing circuitry to perform operations comprising:
detecting an error code of a point of purchase device;
determining, using a small language model, a response corresponding to the error code, the response including at least one action to remedy the error code;
generating, using the small language model, a command line prompt based on the response; and
executing the command line prompt at the point of purchase device.

19. The at least one machine-readable medium of claim 18, wherein the response includes a generic version of the command line prompt and wherein generating the command line prompt includes adding syntax corresponding to a store location of the point of purchase device and a model of the point of purchase device to the generic version of the command line prompt.

20. The at least one machine-readable medium of claim 18, wherein the small language model is trained on approved code patches and troubleshooting fixes that solve a set of error codes.
